(19) United States
(12) Patent Application Publication
(10) Pub. No.: US 2010/0199462 A1
(43) Pub. Date: Aug. 12, 2010

(54) MOUNTING BAND, MOUNTING ARRANGEMENT AND TOOL FOR HANDLING A MOUNTING BAND

(76) Inventor: Gerd Voigt, Berg (DE)

Correspondence Address: Smartpat PLC, 1581 Picadilly Dr., Troy, MI, 48084, US

(21) Appl. No.: 12/766,816

(22) Filed: Apr. 23, 2010

Related U.S. Application Data
(63) Continuation of application No. PCT/DE2008/001841, filed on Nov. 7, 2008.

(30) Foreign Application Priority Data
Nov. 10, 2007 (DE) 10 2007 053 699.4

(51) Int. Cl. B65D 63/10; B65D 63/00; B25B 27/14

(52) U.S. Cl. 24/16 PB; 24/16 R; 29/281.1

(57) ABSTRACT

The invention relates to a mounting band and a tool for handling the mounting band, wherein the mounting band comprises a band extending in a longitudinal direction and having a width (B) and a thickness (H) and (L), the width (B) being larger than the thickness (H), and transversal embossings, which are configured on the band and are disposed transversely to the longitudinal direction (L) substantially across the width (B) of the band, the transversal embossings having variable depths (T) across the width (B) of the band.

### CROSS-REFERENCE TO RELATED APPLICATIONS

This is a continuation of international patent application PCT/DE2008/001841, filed Nov. 7^{th}, 2008, which designated the United States, and which claimed priority to German patent application No. 10 2007 053 699.4, filed Nov. 10^{th}, 2007. These applications are hereby incorporated by reference.

### TECHNICAL FIELD

The present invention generally relates to a mounting band, a mounting arrangement, and a tool for handling a mounting band, and more particularly, to a mounting band having transverse embossings, a mounting arrangement utilizing a mounting band with transverse embossings, and a tool for handling a mounting band with transverse embossings.

### BACKGROUND OF THE INVENTION

Mounting elements for attaching several objects to each other are known in a multitude of forms, for example as hooks, angles, cable ties, pipe ties, mounting bands or holed bands. Mounting elements of this kind can in particular be used to attach objects to buildings and building sections, for the assembly of furniture and furniture items, and the attachment of furnishings such as pictures, curtain rails and flower boxes. A multitude of different tools is in turn required for mounting bands of this kind.

DE 19615629 C1 provides a mounting element made from band material with a number of recesses arranged and formed in such a way that a pre-determined breaking edge is defined along a certain line, on which a static and dynamic load can be placed. The mounting band comprises connection areas with elevations projecting above the surface of the band material, which lead to recesses, the interior dimensions of which equal at least those of the external dimensions of the elevations.

DE7131877, US2003/0145436, EP0779464, WO2005/121623A and DE8510364U1 offer hose and tension clips (worm thread clips) with gears or thread sections with variable depths extending transverse to the hose band, but not across the entire width of the band. The clips comprise a set screw or a thread for tightening, the same being installed in such a way that the internal diameter of the hose clip can be reduced by rotating the set screw. These hose and tension clips serve for fitting one hose end to a fixed connector or to a hose connector; a shortening of the hose band (which is in any case not envisaged as differently dimensioned hose clips are commercially available) is possible only involving substantial effort due to the stability of the material, as the gears or thread sections are not designed to be individually broken off or separated from the band.

GB943140 offers a quick release fastening, comprising a first belt accessory element that is adjusted to fit the same to a belt end, and a second belt accessory element comprising an opening, through which the first belt accessory element can be guided, and that is formed in such a way that the same can be attached to another belt end. The other end of the second belt accessory element is equipped with a projection extending into the opening and arranged on one of two opposing sides at each side end for engaging the back of the first belt accessory element when the first belt accessory element is connected with the second belt accessory element.

A universal mounting equipped with continuous abutting V-shaped transverse grooves is known from DE202005009794U1. These transverse grooves comprise a continuously constant depth, which results in application technical disadvantages during the deformation and separation of the mounting. The tapered shape of the transverse groove ends mean that the same can also cause damage to the components to be connected.

Therefore, in light of the problems associated with existing approaches, there is a need for a mounting band that can be used in a multitude of ways and that can be processed with little effort. There is further a need for a tool for handling the mounting band that is of a simple construction and can be processed together with the mounting band simply and safely.

### SUMMARY OF THE INVENTION

According to a first aspect the invention a mounting band is provided. The band extends in a longitudinal direction and has a width and a thickness, the width being greater than the thickness. Transverse embossings or groves are formed on the band and are distributed substantially along the entire longitudinal extension of the band. The transverse embossings extend across the entire width of the band from one side to the other, following a transverse orientation relative to the band's longitudinal direction. The transverse embossings have variable depths across the width of the band. They are configured such that the mounting band can be bent along the transverse embossings and thereby adjusted to fit the shape of objects to be attached to each other with the mounting band. The transverse embossing are further configured such that the mounting band can be broken off along a transverse embossing and thereby the length of the mounting band be adjusted to fit the objects to be attached to each other. A mounting band as described can be used without damaging the objects to be attached to each other.

The transverse embossings may be configured in many different ways to achieve desirable characteristics of the mounting band. In particular, embossing may be provided with different depth-profiles across the band and different cross-sectional shapes. The depth-profile of an embossing may include sections with zero depth, resulting in intermittent embossings. The number and orientation of embossings on the mounting band may also be varied. The configuration of embossings may be optimized for bands made of different materials. Different configurations of embossings may also be used to achieve desirable characteristics of the mounting band, e.g. to make the mounting band easy to process with a given tool, or optimize the mounting band's ability to be bent while avoiding unintentional breaking.

In one exemplary embodiment the transverse embossings of the mounting band are less pronounced in the side edge area of the band than in the central area of the band which is located in between its two side edge areas. In this embodiment in the area of a transverse embossing the mounting band's edges are thicker than its middle section.

In contrast, in another exemplary embodiment the transverse embossings of the mounting band are more pronounced in the side edge area of the band than in a central area of the band. In this embodiment in the area of a transverse embossing the mounting band's edges are thinner than its middle section.

In yet another embodiment the transverse embossings are intermittent across the width of the band, i.e. the embossing has sections of zero depth. A mounting band according to this embodiment may be folded easily without the risk of breakage.

In another aspect of the invention the transverse embossings comprise a substantially U-shaped cross-section. This has the advantage that the band can be folded easily without the risk of breakage.

In a further embodiment the transverse embossings comprise a substantially V-shaped cross-section, giving the band a substantially saw-tooth like structure in its longitudinal extension. The V-shaped embossing are configured such, that two mounting bands having the same V-shaped embossings may engage with each other. Two similarly formed bands may thereby be firmly coupled with each other in the longitudinal direction of the bands, allowing the transfer of a force from one band into the other in at least in one direction. This applies in particular when the saw-tooth like structure has a predetermined direction of advance in the longitudinal direction of the band, so that the bands can hook into each other particularly well.

In yet another aspect of the invention the mounting band may comprise longitudinal embossings formed on the band, which are arranged in a longitudinal direction. This has the advantage that further attachment points can be located in areas where the longitudinal embossings intersect the transverse embossings.

The band may also comprise holes in the areas where the longitudinal embossings intersect the transverse embossings. This has the advantage that an additional possibility of fitting the mounting band exists without having to drill additional holes into the band. In addition the mounting band can be attached to a solid object in a simple way.

In another embodiment the band comprises hole recesses in the areas where the longitudinal embossings intersect the transverse embossings. This enables a fitting of the same to the mounting band. In addition the advantage that the mounting band itself can be attached in a simple way also exists.

Mounting bands may be made of different materials. In an exemplary embodiment the mounting band may be made of metal, thereby providing high mechanical strength.

Alternatively, the mounting band may be made of plastic. This allows cost effective production of the mounting band, avoids corrosion and provides electrical isolation.

In yet another embodiment the mounting band has a core area and an outer area enclosing the core area at least in part, whereby the outer area comprises the material that is a plastic. This has the advantage that the mounting band can be free from corrosion and provide electrical isolation.

Mounting bands according to another aspect of the invention may comprise a measure of length scale. This has the advantage that no measuring tool other than the mounting band is required, so that a definite time saving is possible during assembly.

The following detailed description of the invention is merely exemplary in nature and is not intended to limit the invention or the application and uses of the invention. Furthermore, there is no intention to be bound by any theory presented in the preceding background of the invention or the following detailed description of the invention.

### BRIEF DESCRIPTION OF THE DRAWINGS

The invention will now be described in more detail with reference to the schematic drawings, whereby:

FIG. 1 is a schematic top view of section of a mounting band in a first embodiment.

FIG. 2 is a schematic top view of section of a mounting band in an alternative embodiment.

FIG. 2a is a schematic top view of a section according to a further embodiment of the mounting band.

FIG. 2b is a schematic top view of a section according to a further embodiment of the mounting band.

FIG. 2c is a schematic top view of a section according to a further embodiment of the mounting band.

FIG. 3 is a cross-sectional view of the mounting band as in FIG. 2a along the line III-III'.

FIG. 4 is a schematic cross-sectional view of a further embodiment of a mounting band.

FIG. 5 is a schematic cross-sectional view of a further embodiment of a mounting band.

FIG. 6 is a cross-sectional view along the line VI-VI′ of the mounting band as in FIG. 2b.

FIG. 7 is a cross-sectional view along the line VII-VII′ of the mounting band as in FIG. 2a.

FIG. 7a is a schematic top view of a further embodiment of the mounting band.

FIG. 7b is a schematic top view of a further embodiment of the mounting band.

FIG. 8 is a schematic cross-sectional view of a further embodiment of the mounting band.

FIG. 9 is a schematic top view of a first embodiment of a mounting arrangement.

FIG. 10 is a schematic cross-sectional view of the mounting arrangement as in FIG. 9 along the line X-X′.

FIG. 11 is a schematic elevation of a tool for handling the mounting band in a first embodiment.

FIG. 12 is a schematic elevation of a tool for handling the mounting band in a further embodiment.

FIG. 13 is a schematic, partially cut away, elevation of a tool for handling the mounting band in a further embodiment.

FIG. 14a-14l show cross-sections of different embodiments of the variable transverse embossings, whereby the broken lines each represent the thickness of the mounting band.

FIG. 15a-15f each show a schematic elevation of different embodiments of the transverse embossings.

Like reference numerals designate identical or corresponding parts throughout the several views.

### DETAILED DESCRIPTION

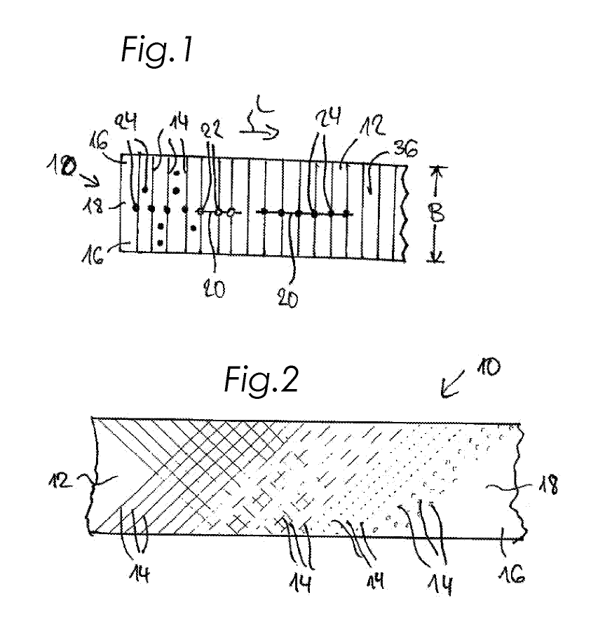

Referring to FIG. 1 a schematic top view of a first embodiment of a mounting band 10 with a band 12 extending in a longitudinal direction L is illustrated. Band 12 has a substantially constant width B and a substantially constant thickness H, as illustrated in a cross sectional view in FIG. 3. The width B of the band 12 is greater than its thickness H, so that the band 12 is substantially formed as a flat strip. The thickness H of the band 12 is preferably approx. 0.2-1.5 mm. The band 12 has edge areas 16 and a central area 18 located between the edge areas 16.

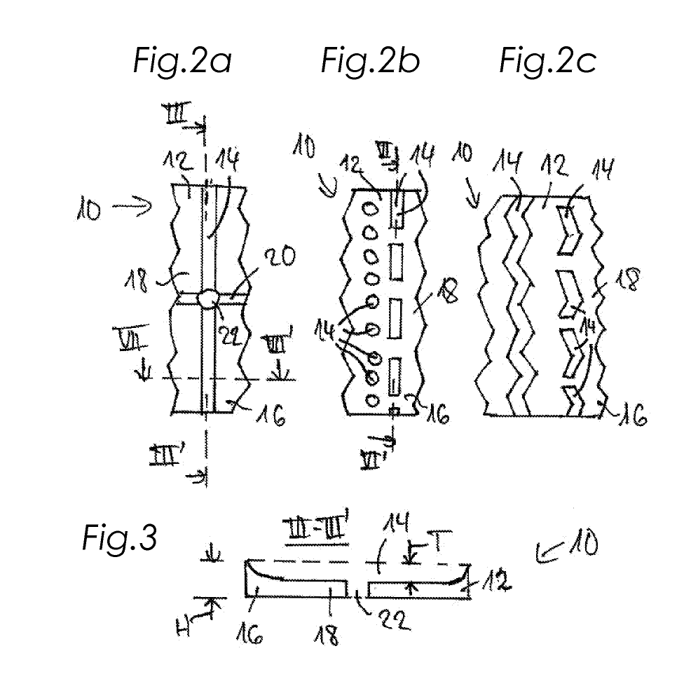

Transverse embossings 14 are located on the band 12 transverse to the longitudinal direction L of the band 12. The transverse embossings 14 preferably serve for bending sections of the band 12 with a pre-defined length without the band 12 being broken at such a transverse embossing 14. The transverse embossings 14 further serve for producing a section of the band 12 with a defined length by repeatedly bending band 12 backwards and forwards. In FIG. 1 the transverse embossings 14 are straight and arranged equidistantly from each other. In this way it is possible to produce sections of band 12 that are evenly graded according to their lengths. In further embodiments the transverse embossings 14 can also take a form other than a straight. Further, transverse embossings 14 may be distributed unevenly along the longitudinal extension of band 12. The transverse embossings 14 preferably extend across the entire width B of band 12, so that it is very simple to bend the band 12 at a transverse embossing 14. The transverse embossings 14 can, as is described in more detail with reference to FIGS. 2a, 2b and 2c, comprise a continuous or an intermittent width B. The transverse embossings 14 are preferably located at a distance of around one millimeter from each other.

The band 12 may further comprise longitudinal embossings 20 which substantially extend in the longitudinal direction L of the band 12. The longitudinal embossings 20 may extend continuously or intermittently.

The transverse embossings 14 and the longitudinal embossings 20 are preferably located on one side 36 of the band 12. Alternatively, the transverse embossings 14 and the longitudinal embossings 20 may also be located on both sides 36 and 38 of band 12.

The transverse embossings 14 and the longitudinal embossings 20 can be produced in the band 12 by means of rollers. In this way the transverse embossings 14 and the longitudinal embossings 20 can be created in the band 12 in a particularly easy and precise way. Transverse embossings 14 and the longitudinal embossings 20 may also be inserted into the band by means of a laser. This represents a particularly precise production method for the transverse embossings 14 and the longitudinal embossings 20.

In areas where the longitudinal embossings 20 intersect the transverse embossings 14 holes 22 or hole recesses 24 are preferably located, which can be formed to receive fitting elements such as screws or nails, with which the mounting band 10 can be firmly mechanically coupled with an object that is to be held, or on which the mounting band 10 itself is held. Alternatively or additionally the holes 22 or the hole recesses 24 can also be formed in areas of the band 12 where no transverse embossings are located, as is illustrated on the left side of FIG. 1. In particular the holes 22 or the hole recesses 24 can also be formed in areas of the band 12 between the transverse embossings 14. The holes 22 or the hole recesses 24 can be located in the edge areas 16 and/or in the central area 18 of the band 12. The holes 22 or the hole recesses 24 are preferably drilled or rolled.

Holes 22 or hole recesses 24 may also be formed by a laser. In this way holes 22 or hole recesses 24 can be produced particularly easily and precisely.

Referring now to FIG. 2 an alternative embodiment of a mounting band 10 is illustrated, in which straight transverse embossings 14 are oriented diagonal to the longitudinal extension of band 12. Diagonal transverse embossings 14, as illustrated, form an X-shaped structure on band 12, extending across the entire width B of the band 12.

Referring now to FIGS. 2a, 2b and 2c one section each of the band 12 is illustrated with the transverse embossings 14, which are formed across the width B of the band 12 either continuously or intermittently.

In the illustrations of FIGS. 2a and 2b, and in FIG. 6, the transverse embossings 14 are formed intermittently and sections of the same are formed as straights or circular. In further embodiments the transverse embossings 14 are formed as ovals. These shapes can facilitate the bending of the band 12. The interruptions in the transverse embossings 14 ensure that a sufficient quantity of band material remains in the areas where the band is bent in order to prevent that the band 12 breaks when it is bent. This is of particular advantage when the band 12 consists of a relatively rigid material or of several relatively rigid materials that might easily tear during bending. The formation of the transverse embossings 14 with interruptions can prevent a tearing or breaking at the transverse embossings 14.

In FIG. 2c the transverse embossings 14 are formed intermittently or continuously as zigzag lines. In further embodiments the transverse embossings 14 are formed intermittently or continuously as wavy lines. The formation of the transverse embossings 14 as zigzag or wavy lines can prevent a tearing or breaking of the transverse embossings 14, in particular where these are intermittent.

FIG. 3 shows a cross-section of the mounting band 10 along the line III-III′ of FIG. 2a, whereby the transverse embossing 14 is less pronounced in the side edge areas 16 of the band 12 than in the central area 18 of the band 12. This means that the depth T of the transverse embossing 14 in the central area 18 of the band 12 is deeper than in the side edge areas 16 of the band 12. In this way it can be prevented that a rigid material of the band 12 in the side edge areas 16 tears when the band 12 is bent and that the band 12 is broken in this way.

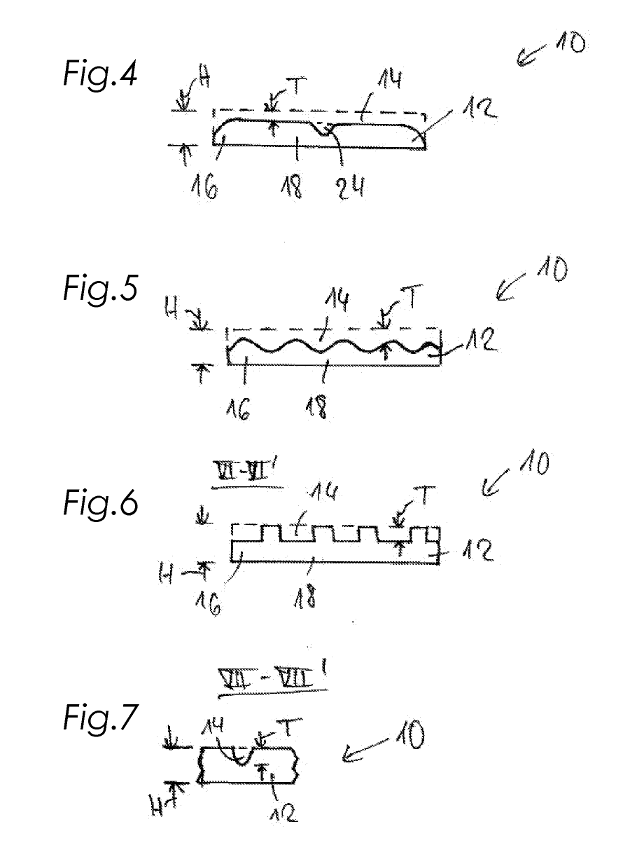

FIG. 4 shows a cross-section of the mounting band 10, whereby the transverse embossing 14 is more pronounced in the side edge areas 16 of the band 12 than in the central area 18 of the band 12. This means that the depth T of the transverse embossing 14 is shallower in the central area 18 of the band 12 than in the side edge areas 16 of the band 12. In this way it is possible to ensure that a flexible material of the band 12, for example a plastic, can be bent reliably and that the sections of the band 12 will remain in their desired positions when the band 12 is bent.

FIG. 5 shows a cross-section of the mounting band 10, whereby the transverse embossing 14 is formed across the width B of the band 12 at a variable depth T. Once again the formation of the intermittent transverse embossings 14 can prevent here that the transverse embossings 14 will tear or break, as described for the embodiments of FIG. 2b and FIG. 2c.

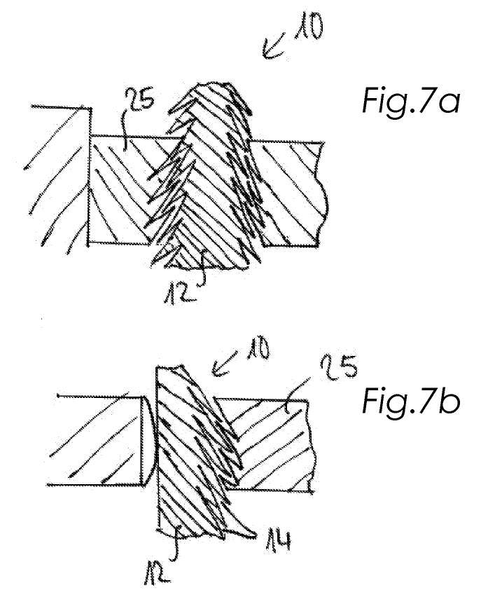

FIG. 7 shows a cross-section of the mounting band 10 along the line VII-VII′ of FIG. 2a, whereby the transverse embossing 14 has a U-shaped cross-section. A U-shaped cross-section is advantageous, as the band 12 can be bent particularly easily and a breaking of the band 12 during bending can be prevented particularly well when the band 12 is bent. This applies in particular with regard to a comparison with a transverse embossing 14 with a V-shaped cross-section.

FIGS. 7a and 7b show the cross-sections of the mounting band 10, whereby the transverse embossings 14 are V-shaped. The band 12 is thus substantially formed in a saw-toothed way across its longitudinal extension. In this way it is possible that the band 12 can interact with similarly formed saw-toothed block 25 and ensure a safe positioning of the band 12 in the block 25 by means of arresting, in particular when the saw-tooth like structure has a pre-determined direction of advance in the longitudinal direction of the band 12.

A spring may be used to push band 12 with its transverse embossings 14 against the block 25, the spring preferably located in the block 25. When required the band 12 can be separated from the block 25 via an access opening, through which the spring can be activated, for example with a screwdriver, in a simple way.

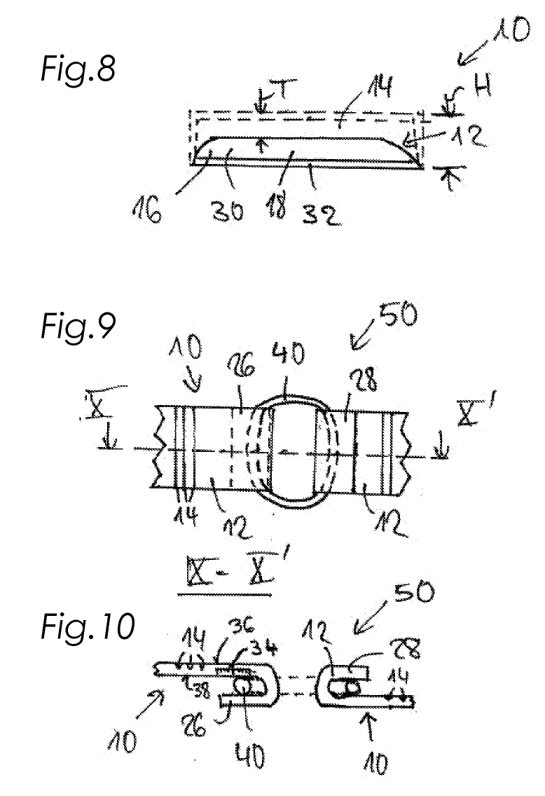

FIG. 8 shows a cross-section of the mounting band 10, whereby the transverse embossing 14 is more pronounced in the side edge areas 16 of the band 12 than in the central area 18 of the band 12. This means that the depth T of the transverse embossing 14 in the central area 18 of the band 12 is shallower than that in the side edge areas 16 of the band 12. The band 12 has a core area 30 and an outer area 32 enclosing the core area 30. Alternatively, the outer area 32 can also be formed in such a way that the same only partially encloses the core area 30. The core area 30 is preferably made from a first material, and the outer area 32 from a second material, whereby the first material of the core area 30 is different from the second material of the outer area 32. It is particularly preferred that the first material of the core area 30 comprises a metal, and the second material of the outer area 32 comprises a plastic. In this case the advantages of a metal, such as high mechanical stability and good shape retention, can be combined with the advantages of a plastic. It is of particular advantage if the material of the outer area 32 has a low electrical conductivity, so that the mounting band 10 can also act as an electrical insulator.

In a further embodiment the band 12 comprises several outer areas 32, so that a layered construction of the mounting band 10 is possible.

In a further embodiment the band 12 is made from a material that is a plastic. In this way it can be ensured that the band 12 has good electrical isolation characteristics. It can further be ensured that the band 12 has good electromagnetic compatibility.

The mounting band 10 may comprise a measure of length scale 34 (FIG. 10). Measuring equipment other than the mounting band 10 is therefore not required to enable a bending or cutting to length of a section of the band 12 to pre-determined length. In this way a short assembly time can be ensured for the assembly of the mounting band 10. The measure of length scale 34 is preferably colored. The measure of length scale 34 can preferably be provided only at the edge of the band 12. In a further embodiment the measure of length scale 34 is applied to a foil connected with the band 12, which can be pulled off the band 12 when required.

The mounting band 10 can be used for the attachment of furnishings such as pictures, curtain rails and flower boxes to buildings and building sections such as windows or doors, as well as during the assembly of furniture and furnishing objects. The mounting band 10 can be bent in the area of the transverse embossings 14. It is therefore possible to adjust the mounting band 10 to suit the shapes and the dimensions of objects to be attached to each other. The mounting band 10 can further be broken off in the area of the transverse embossings 14. The mounting band 10 can therefore be easily adjusted to suit the objects to be attached to each other. In addition the mounting band 10 can be used without damaging the objects to be attached to each other.

FIG. 9 and FIG. 10 illustrate a mounting arrangement 50. This comprises the mounting band 10 with the band 12 and a ring band 40. The ring band 40 preferably has an oval shape. The band 12 has a first end 26 and a second end 28. The first end 26 and the second end 28 of the band 12 are each U-shaped. The U-shaped first end 26 and the U-shaped second end 28 each enclose the ring band 40, so that the same is firmly mechanically coupled with the band 12.

A mounting arrangement 50 shown in FIG. 9 and FIG. 10 can preferably be used as a cable tie, a hole band or pipe tie or as a similar device. For this the two ends 26 and 28 are laid around the sections of the ring band 40 during the fitting of the band 12 to the ring band 40, and then bent around the same. If the connection between the band 12 and the ring band 40 is to be dissolved one of the two ends 26, 28 can be moved backwards and forwards several times until the end 26, 28 breaks off from the band 12 and releases the ring band 40. A mounting arrangement 50 of this type can be used several times.

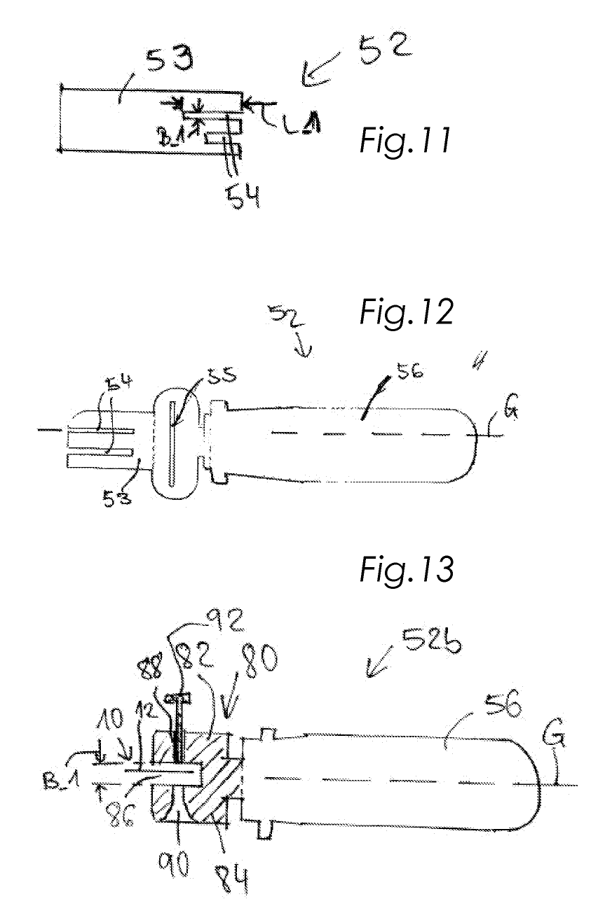

FIG. 11, FIG. 12 and FIG. 13 show tools 52, 52a, and 52b for handling the mounting band 10 in various embodiments. The tool 52, 52a, 52b preferably consists of a manual tool.

FIG. 11 shows the tool 52 for handling the mounting band 10 in a first embodiment. The tool 52 comprises a flat plate band 53, on which slots 54 are arranged. One of the slots 54 has a width B_1 and a length L_1. The width B_1 of one of the slots 54 is a little greater than the thickness H of the band 12 of the mounting band 10. The length L_1 of one of the slots 54 is at least as great as the width B of the band 12 of the mounting band 10. In this way it can be ensured that the band 12 can be inserted into at least one of the slots 54 of the tool 52.

FIG. 12 shows a further embodiment of the tool 52 for handling the mounting band 10 with the flat plate band 53 and slots 54 and 55. The tool 52 of FIG. 12 comprises a handle 56 extending in a handle direction G. At least one of the slots 54 is located parallel and/or at least one of the slots 55 is located vertical to the handle direction G of the handle 56.

In an embodiment of the tool, as shown in FIG. 13, the tool 52b for handling the mounting band 10 comprises a fork-shaped band 80. The fork-shaped band 80 comprises a first part 82 and a second part 84. The first part 82 and the second part 84 of the fork-shaped band 80 are positioned parallel to each other and comprise a gap 86 at a distance B_1 from each other, which is at least the thickness H of the band 12 of the mounting band 10. In this way the band 12 can be inserted into the gap 86. The two parts 82 and 84 of the fork-shaped band 80 each comprise continuous recesses 88 and 90 arranged coaxially to each other. A pin 92 with a tip can be pushed or hammered into the continuous recesses 88 and 90 of the two parts 82 and 84 of the fork-shaped band 80, so that the hole 22 or the hole recess 24 can be inserted into the band 12.

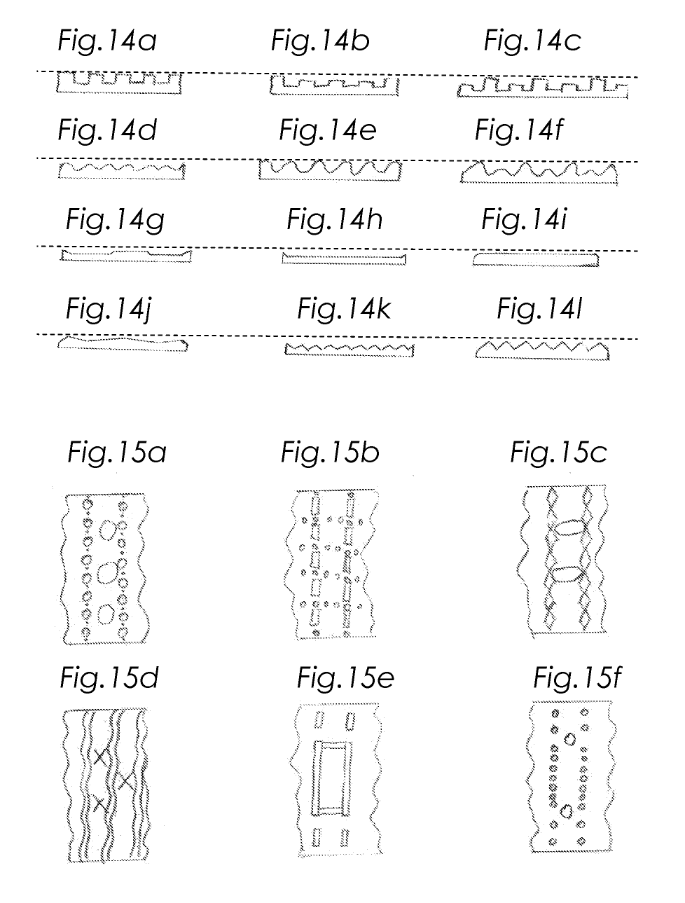

As can be seen from FIG. 14a-l and FIG. 15a-f the transverse embossings 14 can each comprise an arrangement of embossings with different geometries, depths and alignments, or a combination of arrangements with different geometries, depths and alignments.

While the present invention has been described with reference to exemplary embodiments, it will be readily apparent to those skilled in the art that the invention is not limited to the disclosed or illustrated embodiments but, on the contrary, is intended to cover numerous other modifications, substitutions, variations and broad equivalent arrangements that are included within the spirit and scope of the following claims.

What is claimed is:

1. A mounting band extending in a longitudinal direction, having a width between its outer edges and a thickness between its two sides, the width of the mounting band being greater than its thickness, comprising a plurality of transverse embossings located on at least one side of the mounting band, the transverse embossings being oriented transverse to the longitudinal direction of the mounting band, wherein:
a) the transverse embossings extend across the entire width of the mounting band;
b) the transverse embossings extend substantially equidistantly across the entire length of the mounting band; and
c) the depth of the transverse embossings varies across the width of the mounting band.

2. A mounting band as in claim 1, wherein the transverse embossings are deeper at the outer edges of the mounting band than in a central area between the outer edges.

3. A mounting band as in claim 1, wherein the transverse embossings are shallower at the outer edges of the mounting band than in a central area between the outer edges.

4. A mounting band as in claim 1, wherein at least two transverse embossings are distinguished by their geometry, depths, alignment, or a combination thereof.

5. A mounting band as in claim 1, wherein the transverse embossings are intermittent across the width of the mounting band.

6. A mounting band as in claim 1, wherein the transverse embossings have a substantially U-shaped cross-section.

7. A mounting band as in claim 1, wherein the transverse embossings have a substantially V-shaped cross-section, causing the mounting band to exhibit a substantially saw-tooth shaped surface along the longitudinal direction of the band.

8. A mounting band as in claim 1, further comprising longitudinal embossings along the mounting band's longitudinal direction.

9. A mounting band as in claim 8, further comprising holes in areas where the longitudinal embossings intersect the transverse embossings.

10. A mounting band as in claim 8, further comprising hole recesses in areas where the longitudinal embossings intersect the transverse embossings.

11. A mounting band as in claim 1, the mounting band comprising a core area and an outer area, the outer area at least partially enclosing the core area, wherein the outer area is made of plastic.

12. A mounting band as in claim 1, further comprising a measure of length scale.

13. A method for producing a mounting band as in claim 1, wherein the transverse embossings are inserted into the band by a roller or a laser.

14. A mounting arrangement comprising a mounting band as in claim 1, the mounting band having a first end and a second end,
wherein each end of the mounting band is U-shaped, and
wherein the first end and the second end of the mounting band both engage a ring band.

15. A tool for handling a mounting band as in claim 1, comprising a slot having a slot width (B_1) and a slot length (L_1),
wherein the slot width (B_1) is at least half the thickness (H) of the mounting band, and the slot length (L_1) is at least the width (B) of the mounting band, whereby that the mounting band can be inserted into the slot and bent at one of the transverse embossings.
